(19) United States
(12) Patent Application Publication
(10) Pub. No.: US 2019/0041260 A1
(43) Pub. Date: Feb. 7, 2019

(54) NANO-SCALE PIXELATED FILTER-FREE COLOR DETECTOR

(71) Applicant: The Regents of the University of California, Oakland, CA (US)

(72) Inventors: Xiang ZHANG, Alamo, CA (US); Xingjie NI, State College, PA (US); Lin LI, Albany, CA (US); Xuexin REN, Berkeley, CA (US); Yuan WANG, Albany, CA (US); Shuang ZHANG, Birmingham (GB)

(73) Assignee: The Regents of the University of California, Oakland, CA (US)

(21) Appl. No.: 16/072,108

(22) PCT Filed: Jan. 25, 2017
(86) PCT No.: PCT/US2017/014981

§ 371 Date: Jul. 23, 2018

Related U.S. Application Data
(60) Provisional application No. 62/293,622, filed on Feb. 10, 2016.
(60) Provisional application No. 62/286,770, filed on Jan. 25, 2016.

(51) Int. Cl. G01J 1/44; G01J 5/60; G02B 5/00; G02F 1/17; G01J 3/50

(52) U.S. Cl. CPC G01J 1/44; G01J 5/60; G02F 2203/15; G02F 1/17; G01J 3/50; G02B 5/008

(57) ABSTRACT

According to some embodiments of the invention, an electro-optic device includes a first plurality of electrodes, a second plurality of electrodes spaced apart from the first plurality of electrodes, and an active layer between the first plurality of electrodes and the second plurality of electrodes. The active layer comprises a plurality of electromagnetic resonators. At least one of the first plurality of electrodes and the second plurality of electrodes is at least partially transparent to light of a spectral range that can be absorbed or emitted by the plurality of electromagnetic resonators. The first and second plurality of electrodes are electrically connected to the plurality of electromagnetic resonators. The spacings between at least a selected pair of the plurality of electromagnetic resonators is provided such that a real component of a coupling coefficient between the selected pair of the plurality of electromagnetic resonators is substantially canceled.

This application claims priority to U.S. Provisional Application No. 62/286,770 filed Jan. 25, 2016, and U.S. Provisional Application No. 62/293,622 filed Feb. 20, 2016, the entire content of which are hereby incorporated by reference.

### BACKGROUND

### 1. Technical Field

The field of the currently claimed embodiments of this invention relates to color detectors and emitters, and more specifically to nano-scale pixelated filter-free color detectors and emitters.

### 2. Discussion of Related Art

Conventional cameras achieve color imaging by patterning color filters on top of photo detectors. However, due to the low absorption coefficients, these color filters cannot be made thinner than a few hundred nanometers, forbidding the realization of very small pixels. In addition, they are usually not durable under ultraviolet illumination or high temperatures. Therefore, there remains a need for nano-scale color detectors that are durable under ultraviolet illumination and that can withstand high temperatures.

### SUMMARY

According to some embodiments of the invention, an electro-optic device includes a first plurality of electrodes, a second plurality of electrodes spaced apart from the first plurality of electrodes, and an active layer between the first plurality of electrodes and the second plurality of electrodes. The active layer comprises a plurality of electromagnetic resonators. At least one of the first plurality of electrodes and the second plurality of electrodes is at least partially transparent to light of a spectral range that can be absorbed or emitted by the plurality of electromagnetic resonators. The first and second plurality of electrodes are electrically connected to the plurality of electromagnetic resonators. The spacings between at least a selected pair of the plurality of electromagnetic resonators is provided such that a real component of a coupling coefficient between the selected pair of the plurality of electromagnetic resonators is substantially canceled.

According to some embodiments of the invention, a method of forming an electro-optic device includes forming a first plurality of electrodes, forming an active layer electrically connected to the first plurality of electrodes, the active layer comprising a plurality of electromagnetic resonators, and forming a second plurality of electrodes electrically connected to the active layer. Forming the active layer includes forming at least two electromagnetic resonators at a distance from each other that is less than the resonance wavelengths of each of the two electromagnetic resonators and such that a real component of a coupling coefficient between the at least two electromagnetic resonators is substantially canceled.

### BRIEF DESCRIPTION OF THE DRAWINGS

Further objectives and advantages will become apparent from a consideration of the description, drawings, and examples.

FIG. 1 is a schematic drawing of an electro-optic device according to some embodiments of the present invention;

FIG. 2 shows an active layer comprising a plurality of electromagnetic resonators;

FIG. 3 illustrates concepts of coupling between resonators;

FIG. 4 shows a photonic system comprising two optical nanoantennas made of silicon;

FIG. 5 illustrates numerical retrieval of the indirect anti-Hermitian coupling between two dielectric nanoantennas;

FIG. 6 shows three separate lattices of cylinders;

FIG. 7 shows absorption spectra for three individual lattices;

FIG. 8 shows an example in which lattices of resonators that resonate at green, blue, and red wavelengths are combined;

FIG. 9 shows real and imaginary parts of the coupling coefficient when a₁ is parallel to the electric field direction;

FIG. 10 shows a plot of the real and imaginary parts of the coupling coefficient when the angle between a₁ and the electric field direction is 60 degrees;

FIG. 11 shows an example in which cylinders that resonate at three different wavelengths are arranged linearly;

FIG. 12 shows the absorption spectra for three sub-lattices, each having a distinctive resonance frequency, which have all been combined into a single lattice as depicted in FIG. 11;

FIG. 13A shows an example of an isotropic lattice comprising two sub-lattices;

FIG. 13B shows the real (squares) and imaginary (circles) parts of the coupling coefficient as a function of the spacing between the resonators of two different sub-lattices;

FIG. 14 shows the absorption spectra for the two sub-lattices individually (dashed lines) and combined into a single lattice (solid lines);

FIG. 15 shows an isotropic lattice geometry combining three colors;

FIG. 16 shows the real (squares) and imaginary (circles) parts of the coupling coefficient as a function of the distance between blue and green cylinders;

FIG. 17 shows the real (squares) and imaginary (circles) parts of the coupling coefficient as a function of the distance between green and red cylinders;

FIG. 18 demonstrates color sorting with the isotropic geometry of FIG. 15;

FIG. 19 shows the combined lattice with incident light at 520 nm (left image), 540 nm (center image), and 570 nm (right image);

FIG. 20 shows an isotropic array that is sensitive to five different wavelengths;

FIG. 21 shows an array comprising three sub-lattices, each resonating at a different frequency, wherein each resonator is a polarization-sensitive antenna; and

FIG. 22 shows an array comprising five sub-lattices that resonate at five different frequencies, each sub-lattice having polarization-sensitive resonators that are arranged in four different orientations.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

We have developed a sub-micron pixelated color detector and/or emitter according to some embodiments of the current invention, based on the electromagnetic resonance of dielectric nano-structures. At sub-micron pixel size, the performance of color filters is limited by detrimental crosstalk between neighboring pixels. Some embodiments of the current invention can solve this problem via precise mode control of nano-structures by employing the theory of anti-Hermitian mode coupling. In some embodiments of the current invention, a color sorting metasurface is designed based on 3D silicon particles. From Mie theory, high-index dielectric or semiconductor particles support geometrical resonances, the first and second orders of which are magnetic and electric dipole modes. Upon excitation, the magnetic dipole mode can have a very strong field enhancement inside the particle. If the structure material is absorptive, then strong selective color absorption can occur due to the magnetic dipole resonance. If the structure material is active, then strong selective color emission can occur from the magnetic dipole resonance.

Embodiments of the invention can achieve pixel size down to less than a few microns, and are superior to organic dyes regarding stability and design flexibility. Embodiments of the invention present the opportunity for very high photon efficiency.

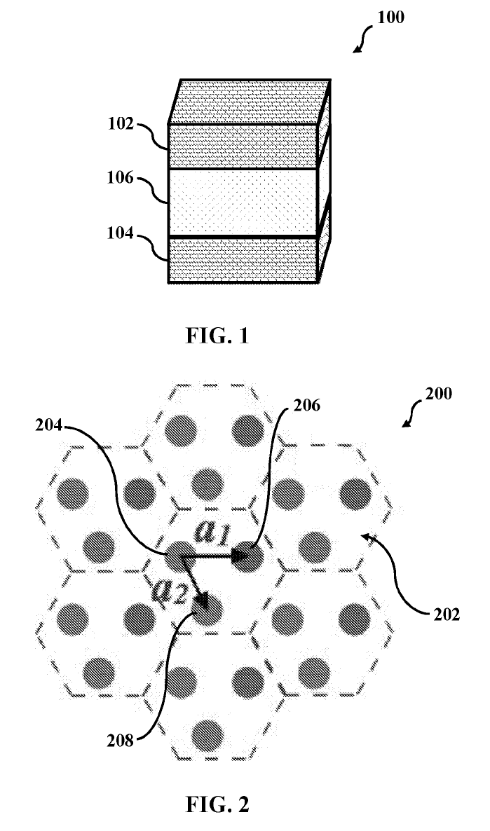

FIG. 1 shows an electro-optic device according to some embodiments of the invention. The electro-optic device 100 includes a first plurality of electrodes 102, and a second plurality of electrodes 104 spaced apart from the first plurality of electrodes 102. The electro-optic device 100 further includes an active layer 106 between the first plurality of electrodes 102 and the second plurality of electrodes 104. The active layer 106 comprises a plurality of electromagnetic resonators. For example, FIG. 2 shows an active layer 200 comprising a plurality of electromagnetic resonators 202. At least one of the first plurality of electrodes 102 and the second plurality of electrodes 104 is at least partially transparent to light of a spectral range that can be absorbed or emitted by the plurality of electromagnetic resonators 202. The first and second plurality of electrodes 102, 104 are electrically connected to the plurality of electromagnetic resonators 202. Spacings between at least a selected pair of the plurality of electromagnetic resonators 202 is provided such that a real component of a coupling coefficient between the selected pair of the plurality of electromagnetic resonators 202 is substantially canceled. For example, in FIG. 2, the spacing a₁ between electromagnetic resonator 204 and electromagnetic resonator 206 is provided such that a real component of a coupling coefficient between electromagnetic resonator 204 and electromagnetic resonator 206 is substantially canceled.

According to some embodiments of the invention, all of the plurality of electromagnetic resonators 202 are arranged to have substantially no real component of coupling coefficients between each other. According to some embodiments, each electrode of the first plurality of electrodes 102 is electrically connected to a respective one of the plurality of electromagnetic resonators 202, and each electrode of the second plurality of electrodes 104 is electrically connected to a respective one of the plurality of electromagnetic resonators 202 such that each of the plurality of electromagnetic resonators 202 can be electronically addressed for at least one of detection or transmission of electromagnetic energy at corresponding resonating wavelengths.

According to some embodiments of the invention, each of the plurality of electromagnetic resonators 202 absorbs at a wavelength of light for detection. According to some embodiments, each of the plurality of electromagnetic resonators 202 emits at a wavelength of light for emission.

According to some embodiments of the invention, the plurality of electromagnetic resonators 202 includes at least one resonator that resonates at a frequency of blue light, at least one resonator that resonates at a frequency of green light, and at least one resonator that resonates at a frequency of red light. According to some embodiments, each the plurality of electromagnetic resonators 202 resonates at a different frequency, and the electro-optic device is a spectrometer. According to some embodiments, the plurality of electromagnetic resonators 202 is sensitive to a polarization of light incident upon the first or second electrode 102, 104.

According to some embodiments of the invention, the plurality of electromagnetic resonators 202 forms an array of at least one of electromagnetic detectors or electromagnetic emitters.

According to some embodiments of the invention, a shortest distance between any two of the plurality of electromagnetic resonators is less than a wavelength of light absorbed or emitted by the plurality of electromagnetic resonators. For example, in FIG. 2, each of a₁, a₂, and the distance between resonators 206 and 208 is less than a wavelength of light absorbed or emitted by the plurality of electromagnetic resonators 202.

According to some embodiments of the invention, the plurality of electromagnetic resonators 202 includes at least one resonator that resonates at a frequency of ultraviolet light. According to some embodiments, the plurality of electromagnetic resonators 202 includes at least one resonator that resonates at a frequency of near-infrared light.

A method of forming an electro-optic device according to some embodiments of the invention includes forming a first plurality of electrodes 102, and forming an active layer 106 electrically connected to the first plurality of electrodes 102. The active layer 106 includes a plurality of electromagnetic resonators 202. The method further includes forming a second plurality of electrodes 104 electrically connected to the active layer 106. Forming the active layer 106 includes forming at least two electromagnetic resonators 204, 206 at a distance a₁ from each other that is less than the resonance wavelengths of each of the two electromagnetic resonators 204, 206 and such that a real component of a coupling coefficient between the at least two electromagnetic resonators 204, 206 is substantially canceled.

According to some embodiments, each electrode of the first plurality of electrodes 102 is formed to be electrically connected to a respective one of the plurality of electromagnetic resonators 202, and each electrode of the second plurality of electrodes 104 is formed to be electrically connected to a respective one of the plurality of electromagnetic resonators 202 such that each electromagnetic resonator can be electrically addressed for at least one of detection or transmission or emission at a corresponding resonance wavelength.

According to some embodiments, the plurality of electromagnetic resonators 202 are formed in an array. According to some embodiments, the array is a hexagonal array comprising three resonators per hexagon. According to some embodiments, each of the plurality of resonators has a cylindrical shape.

Resonant dielectric structures that have very low material loss were selected to make a metasurface. However, the field confinement in dielectric structures does not compare favorably with the plasmonic resonators, creating new problems such as radiation loss and detrimental cross talking between neighboring resonators. To address these problems, the theory of anti-Hermitian coupling [1] is used to obtain greater control of the coupling among the resonators.

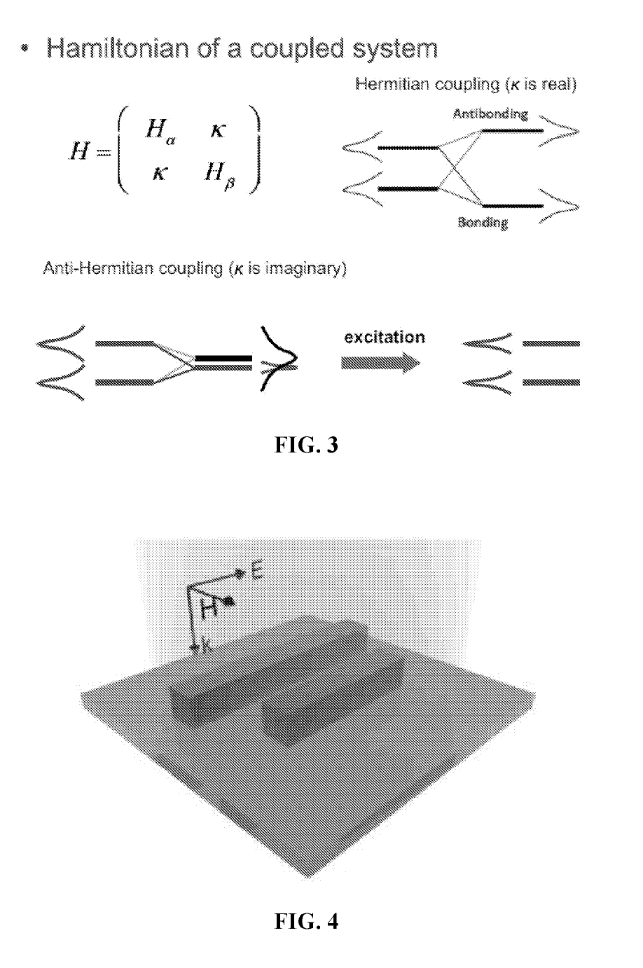

The governing Hamiltonian for a quantum open system with a single continuum channel can be mapped to a photonic system having an array of dielectric dipole antennas with the same orientation positioned in proximity to each other (separations<wavelength). At very small separations, the real (Hermitian) part of the coupling coefficient exhibits a large negative value, which is dominated by the direct near-field coupling between the two antennas. With increasing distance, the near-field coupling decreases rapidly, and the real part of the coupling crosses zero, where the direct near-field coupling is canceled by the Cauchy principal value of the indirect coupling among the bound states mediated by the open channels, leaving a purely anti-Hermitian coupling between the two antennas. This concept is illustrated in FIG. 3. This treatment can be applied to a photonic system to sharpen photonic resonances. For particular applications, the coupling between the antennas will be “substantially cancelled.” The term substantially cancelled means that the coupling is reduced to an amount sufficiently small to be advantageous for the particular application. In practical applications, “substantially cancelled” does not require the coupling to be exactly zero.

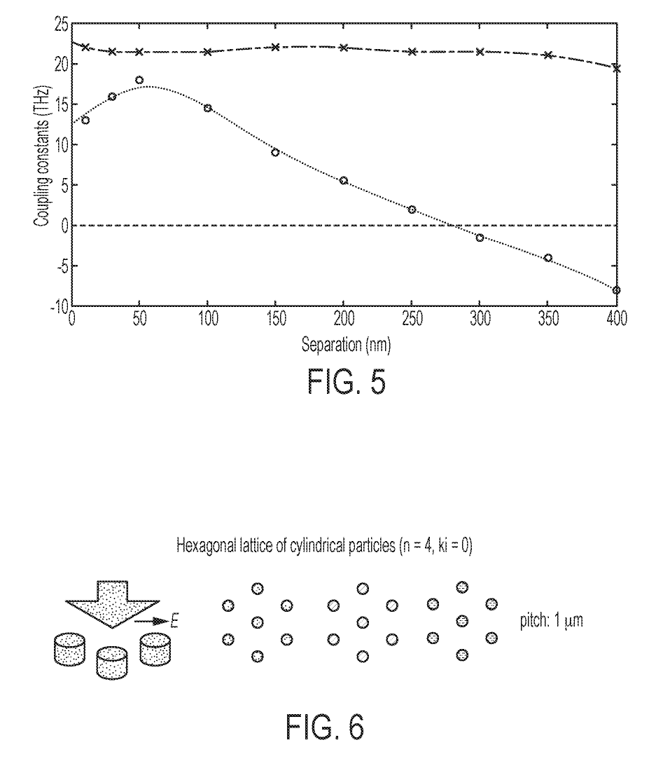

A pure dielectric system exhibiting anti-Hermitian indirect coupling mediated by a single open channel has been designed. The system is capable of separating and focusing light into nanometer scales with low loss. FIG. 4 shows a photonic system comprising two optical nanoantennas made of silicon. FIG. 5 illustrates numerical retrieval of the indirect anti-Hermitian coupling between two dielectric nanoantennas. The plot shows the retrieved real part (circles) and imaginary part (crosses) of the optical coupling constant between the two antennas as a function of their edge-to-edge separation. The lower and upper solid lines are the polynomial fittings for the real and imaginary parts, respectively. The real and imaginary values of the optical coupling can be used to determine a separation distance for the two dielectric nanoantennas that minimizes crosstalk between them.

Conventional cameras achieve color imaging by patterning color filters on top of photo detectors. However, due to the low absorption coefficients, these color filters cannot be made thinner than a few hundred nanometers, forbidding the realization of very small pixels. In addition, they are usually not durable under ultraviolet illumination or high temperature. Alternatively, optically thick plasmonic color filters have been realized [2, 3], which can achieve pixel size down to a few microns. They are superior to organic dyes in terms of stability and design flexibility. However, the plasmonics color filters are still based on the conventional filtering scheme, which is intrinsically ineffective. Recently, a filter-free color image sensor based on selective color absorption of silicon nanowires was demonstrated [4], presenting the opportunity for very high photon efficiency. Although silicon has been described in some examples as a semiconductor material for some embodiments of the current invention, the general concepts of the current invention are not limited to only that material. In general, materials that absorb in the desired wavelength range for a resonator with selected geometrical dimensions can be used.

There are a wide range of semiconductors known to be useful as absorbers for resonators across a broad range of wavelengths. The concepts of the current invention can be applied to resonators across a broad range of wavelengths of the electromagnetic spectrum. The broad range spans from deep ultraviolet, through ultraviolet (UV), visible, infrared, and far infrared to millimeter wavelengths, for example.

We have developed a dielectric sub-micron pixelated metasurface color absorber, based on the resonant absorption of silicon nano-structures. At sub-micron pixel size, the performance of color filters is limited by detrimental crosstalk between neighboring pixels. The devices and methods described herein solve this problem via precise mode control of nano-structures by employing the theory of anti-Hermitian mode coupling. In this work, an absorptive color sorting metasurface is designed based on 3D silicon particles, since they are more sturdy and easier to fabricate than silicon nanowires. From Mie theory, high-index dielectric or semiconductor particles support geometrical resonances, the first and second orders of which are magnetic and electric dipole modes. Upon excitation, the magnetic dipole mode can have a very strong field enhancement inside the particle. If the structure material is absorptive, then strong selective color absorption from the magnetic dipole resonance can be achieved. If the structure material is active, then strong selective color emission can occur from the magnetic dipole resonance.

According to some embodiments, silicon cylinder particles are patterned into a lattice. The lattice can be a hexagonal lattice or a rectangular lattice, for example, though the embodiments of the invention are not limited to these types of lattices. By varying the cylinder size, chromatic light absorption or emission is achieved at different wavelengths. For example, the cylinders according to some embodiments, such as those for which data is provided in the figures, have a height of 120 nm. For absorbing or emitting ultraviolet light, the radii of the cylinders is about 20-40 nm, and height is about 40-80 nm. For absorbing or emitting near-infrared light, the radii of the cylinders is about 80-150 nm, and the height is about 160-300 nm. Thus, the radii of the cylinders according to some embodiments is between about 20 nm and about 150 nm. The height of the cylinders according to some embodiments is between about 40 nm and about 300 nm. The radius and height may be chosen based on the desired absorption or emission wavelength.

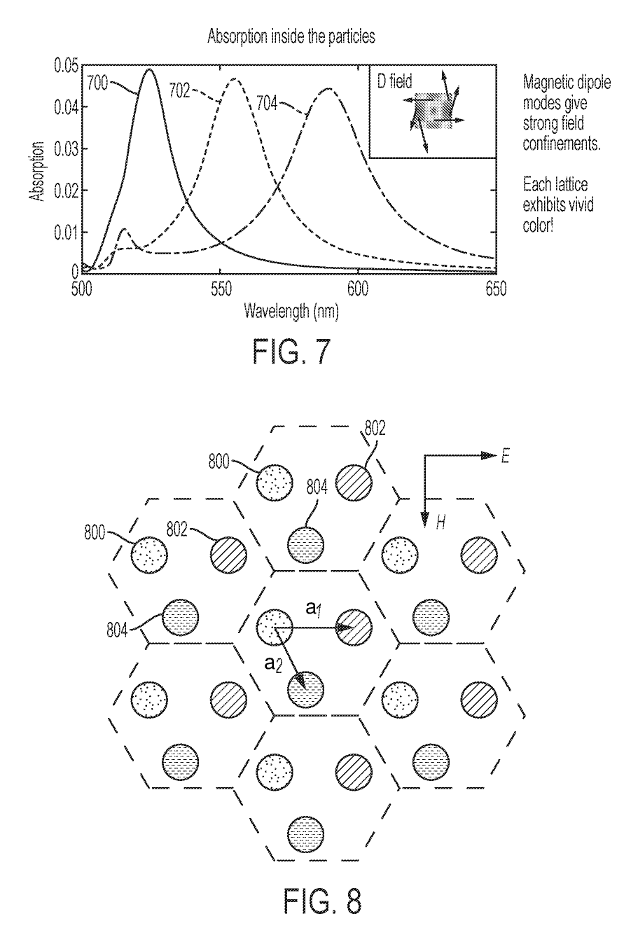

For example, FIG. 6 shows three lattices of cylinders. Each lattice has cylinders whose absorption (or emission) peaks at a particular wavelength. For example, the cylinders of the first lattice resonate at a first frequency, while the cylinders of the second lattice resonate at a second frequency. Each cylinder can be viewed as a single pixel, with sub-micron pixel size. FIG. 7 shows absorption spectra for three individual lattices. Line 700 is for a lattice with cylinders that resonate at wavelengths around 525 nm, line 702 is for a lattice with cylinders that resonate at wavelengths around 555 nm, and line 704 is for a lattice with cylinders that resonate at wavelengths around 590 nm.

For color imaging applications, three lattices are patterned together, for example, lattices that resonate at red, green, and blue wavelengths. FIG. 8 shows an example in which a lattice of resonators that resonate at green wavelengths 800, a lattice of resonators that resonate at blue wavelengths 802, and a lattice of resonators that resonate at red wavelengths 804 are combined. Forming the three lattices with close proximity between resonators will very likely induce color crosstalk among adjacent pixels. Here, in order to solve this problem, the concept of anti-Hermitian coupling is employed to get better control of the mutual couplings among the lattices.

The three sub-lattices couple to one another via direct near field as well as far field radiation, where the latter gives rise to complex coupling coefficients. It has been demonstrated in [1] that when the real part of the overall coupling coefficient is cancelled to zero, each resonance mode gets even sharper in spectrum, instead of getting broader.

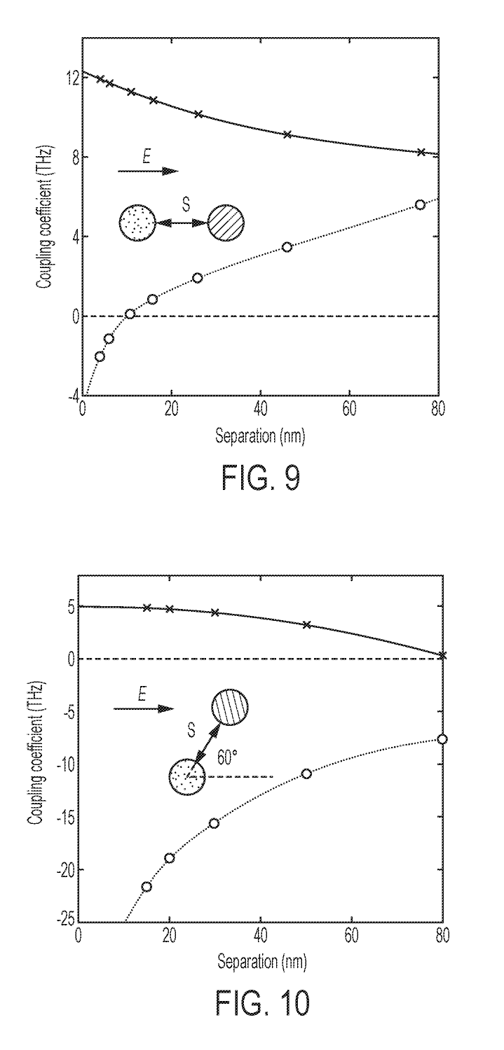

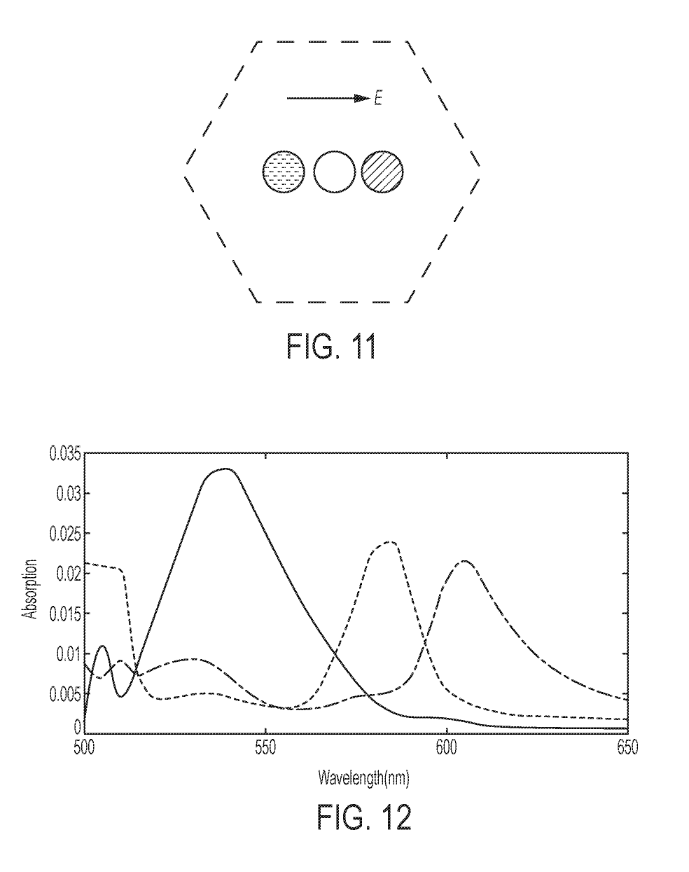

We calculated the coupling coefficients among the three sub-lattice modes with respect to their relative position shifts, which are labeled a₁ and a₂ in FIG. 8. However, we arranged the three lattices linearly, as shown in FIG. 11. When a₁ is parallel to the electric field direction, as shown in FIG. 8, the coupling constant has an imaginary part that is only slightly smaller than the single lattice decay rate, which means that the green and blue lattices primarily couple to a same decay channel. The real and imaginary parts of the coupling coefficient for this scenario are plotted in FIG. 9. The imaginary part slowly decreases as the separation increases. The real part, on the other hand, crosses zero at around 10 nm separation. This is where the negative near field coupling exactly cancels with the indirect coupling and the anti-Hermitian coupling occurs.

However, when there is a large angle between a₁ and the electric field direction, the indirect coupling between the two lattices becomes very small and the anti-Hermitian point does not appear. This is illustrated in FIG. 10, which shows a plot of the real and imaginary parts of the coupling coefficient when the angle between a₁ and the electric field direction is 60 degrees.

By choosing a₁ and a₂ accordingly, we are able to achieve distinctive excitation of each chromatic pixel, even at sub-micron pixel size. For example, a₁ may be selected such that the crosstalk between the cylinders of the green lattice and the cylinders of the blue lattice is minimized. Similarly, a₂ may be selected such that the crosstalk between the cylinders of the green lattice and the cylinders of the red lattice is minimized. Accordingly, we arrange the three lattices linearly and a unit cell is shown in FIG. 11. The separation between nearest cylinders is 10 nm. The cross talk between the cylinders of the blue lattice and the cylinders of the red lattice may be less problematic, because the blue and red wavelengths are farther apart in the electromagnetic spectrum than the other two pairs of wavelengths. FIG. 12 shows the absorption spectra for three sub-lattices, each having a distinctive resonance frequency, that have all been combined into a single lattice. This design is sensitive to the polarization of the incident light. It has the strongest response when the electric field is parallel to the line of the resonators.

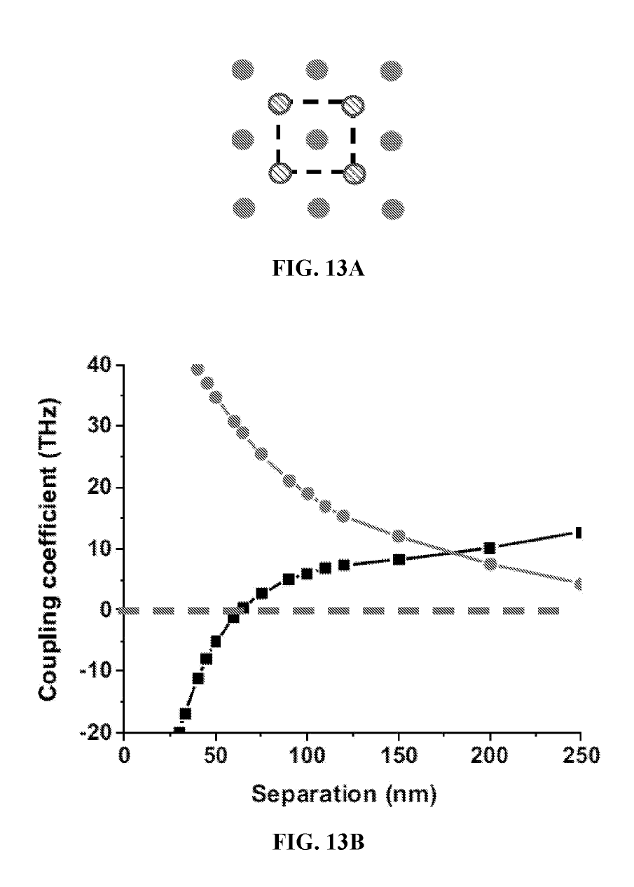

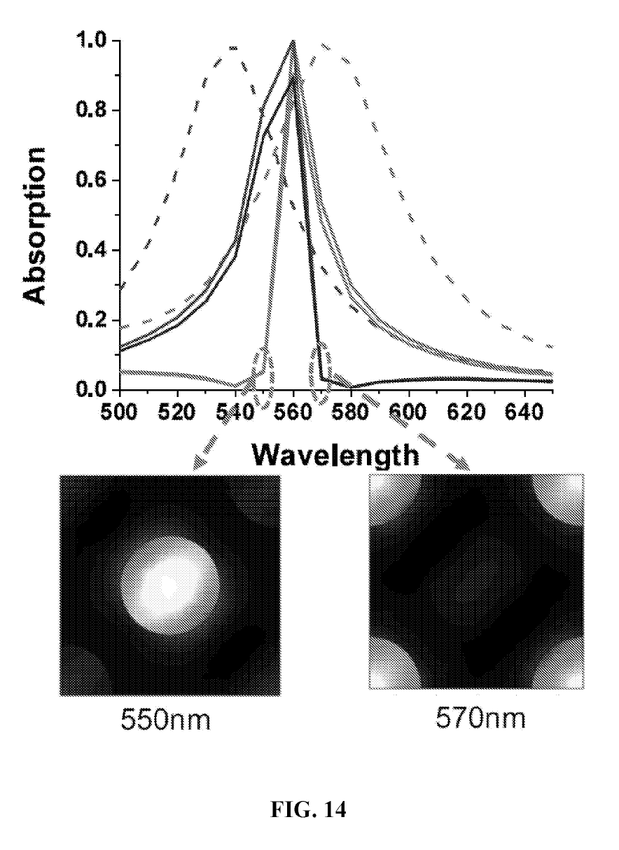

FIG. 13A shows an example of an isotropic lattice comprising two sub-lattices. FIG. 13B shows the real (squares) and imaginary (circles) parts of the coupling coefficient as a function of the spacing between the resonators of the two different sub-lattices. Anti-Hermitian coupling occurs at 62 nm separation. FIG. 14 shows the absorption spectra for the two sub-lattices individually (dashed lines) and combined into a single lattice (solid lines). The lower images show a resonator of one sub-lattice of the combined lattice resonating at 550 nm, and resonators of the other sub-lattice of the combined lattice resonating at 570 nm. Thus, the combined lattice exhibits high resolution for two wavelengths separated by just 20 nm.

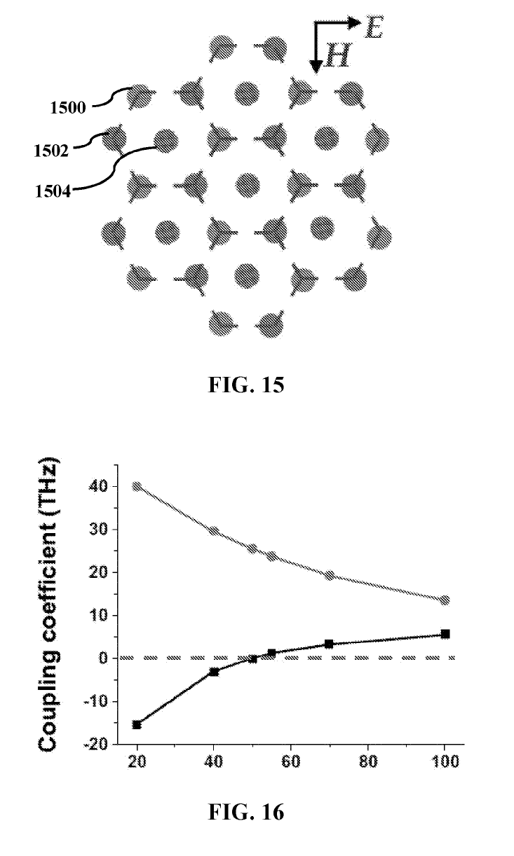

FIG. 15 shows an isotropic lattice geometry combining three colors. The term “color” is used to indicate a characteristic wavelength at which the resonators of a sub-lattice resonate. These wavelengths may be in the visible range of the electromagnetic spectrum, or may be outside the visible range. The sub-lattices in FIG. 15 will be described as green 1500, blue 1502, and red 1504, though the embodiments of the invention are not limited to sub-lattices having wavelengths associated with these colors. In FIG. 15, the combined sub-lattices form a hexagonal shape with alternating green and blue cylinders at the vertices of each hexagon, and a red cylinder at the center of each hexagon. This design is less polarization sensitive and can work for all electric field directions that are in the lattice plane.

FIG. 16 shows the real (squares) and imaginary (circles) parts of the coupling coefficient as a function of the distance between the blue and green cylinders. According to some embodiments, the blue cylinders have a radius of 56 nm, and the green cylinders have a radius of 60 nm. The cylinders exhibit anti-Hermitian coupling at 51 nm separation.

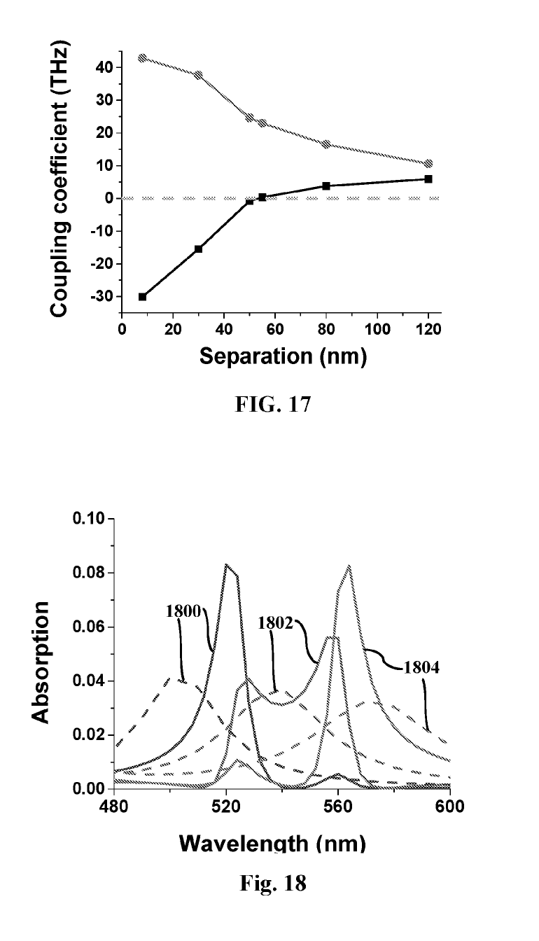

FIG. 17 shows the real (squares) and imaginary (circles) parts of the coupling coefficient as a function of the distance between the green and red cylinders. According to some embodiments, the red cylinders have a radius of 64 nm. The cylinders exhibit anti-Hermitian coupling at 54 nm separation.

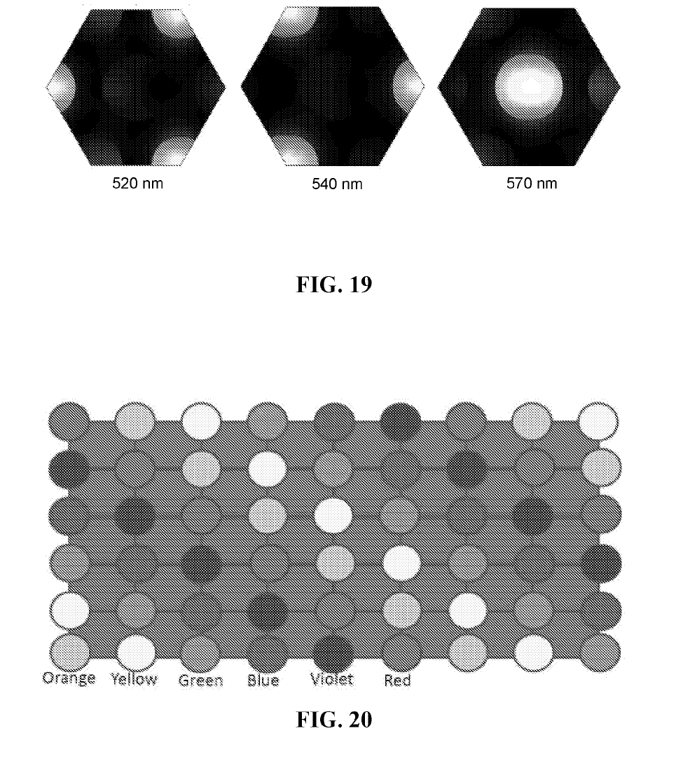

FIG. 18 demonstrates color sorting with the isotropic geometry of FIG. 15. FIG. 18 shows the absorption spectra for the blue sub-lattice 1800, the green sub-lattice 1802, and the red sub-lattice 1804, individually (dashed) and combined into a single lattice (solid). FIG. 19 shows the combined lattice with incident light at 520 nm (left image), 540 nm (center image), and 570 nm (right image). The images demonstrate how the combined lattice differentiates between the three different wavelengths.

While some embodiments of the invention employ resonators that are sensitive to red, green, and blue light, the embodiments of the invention are not limited to these colors. The design can have more, fewer, or different colors than RGB. For example, FIG. 20 shows an isotropic array that is sensitive to six different wavelengths. The methods described herein may be used to position pairs of cylinders with adjacent wavelengths to minimize crosstalk. Also, the device can include resonators that resonate at frequencies that are totally outside the visible range (no red, green, or blue). For example, the resonators can resonate at NIR frequencies, for example, at 1.1, 1.2, 1.3, 1.4, 1.5 μm wavelength, which is good for telecommunication applications. According to some embodiments, the resonators can resonate at UV frequencies, for example, at 250, 260, 270, 280, and 290 nm, which is important for DNA analysis.

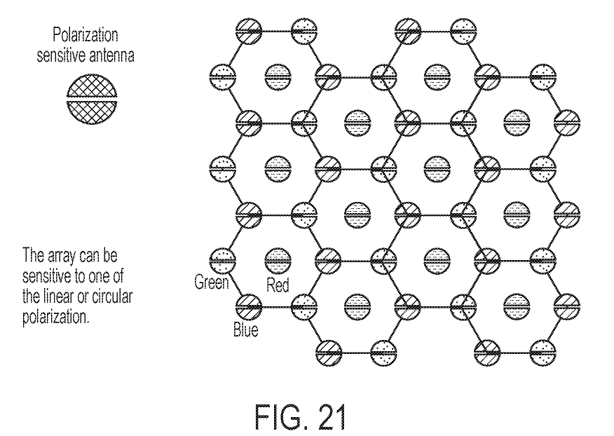

FIG. 21 shows an array comprising three sub-lattices, each resonating at a different frequency, similar to FIG. 15. However, in FIG. 21, each resonator is a polarization sensitive antenna. The array can be sensitive to linear or circular polarization.

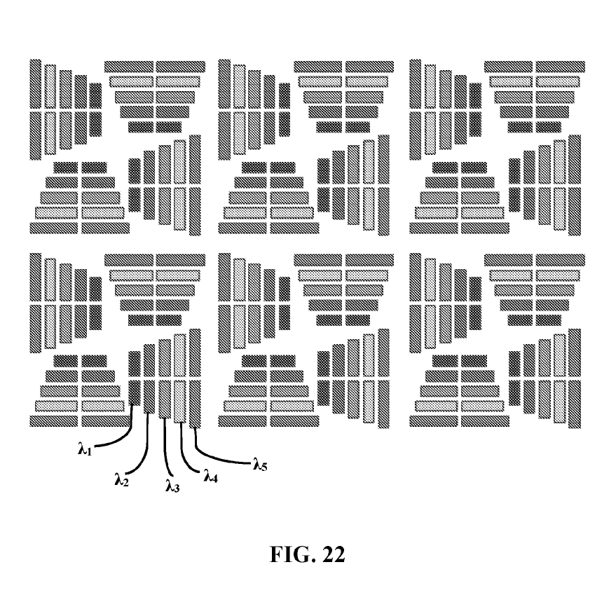

FIG. 22 shows an array comprising five sub-lattices, which resonate at five different frequencies, λ₁-λ₅. The five sub-lattices each have polarization-sensitive resonators that are arranged in four different orientations. Thus, the lattice is sensitive to at least five wavelengths and to all polarizations of the electric field that are parallel to the lattice surface. Further, the lattices can be extended to a third dimension, perpendicular to the current lattice surface, so that the polarization of the electric filed that is perpendicular to the current lattice surface can also be detected.

The lattices described herein can be combined with a first and second plurality of electrodes such that a pair of electrodes is connected to a single cylinder, or to a sub-lattice comprising a group of cylinders with a particular resonance frequency. Thus, the lattices can be implemented as detectors, if the cylinders absorb light, or emitters if the cylinders emit light. The sub-lattices, each connected to one or more separate pairs of electrodes, can be combined into a single lattice to form a detector or emitter that detects or emits at a plurality of frequencies and wavelengths.

### REFERENCES

[1] S. Zhang, Z. Ye, Y. Wang, Y. Park, G. Bartal, M. Mrejen, X. Yin and X. Zhang, “Anti-Herimitian plasmonics coupling of an array of gold thin-film antennas for controlling light at the nanoscale”, Physical Review Letters 109, 193902 (2012).
[2] T. Xu, Y.-K. Wu, X. Luo and L. J. Guo, “Plasmonic nanoresonators for high-resolution colour filtering and spectral imaging”, Nature communication 1, 59 (2010)
[3] S. Yokogawa, S. P. Burgos and H. A. Atwater, “Plasmonic color filters for CMOS image sensor applications”, Nano Letters 12, 4359-4354 (2012).
[4] H. Park, Y. Dan, K. Seo, Y. Yu, P. K. Duane, M. Wober and K. B. Crozier, “Filter-free image sensor pixels comprising silicon nanowires with selective color absorption”, Nano Letters 14.4, 1804-1809 (2014).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. An electro-optic device comprising:
a first plurality of electrodes;
a second plurality of electrodes spaced apart from said first plurality of electrodes; and
an active layer between said first plurality of electrodes and said second plurality of electrodes,
wherein said active layer comprises a plurality of electromagnetic resonators,
wherein at least one of said first plurality of electrodes and said second plurality of electrodes is at least partially transparent to light of a spectral range that can be absorbed or emitted by said plurality of electromagnetic resonators,
wherein said first and second plurality of electrodes are electrically connected to said plurality of electromagnetic resonators, and
wherein spacings between at least a selected pair of said plurality of electromagnetic resonators is provided such that a real component of a coupling coefficient between said selected pair of said plurality of electromagnetic resonators is substantially canceled.

2. The electro-optic device of claim 1, wherein all of said plurality of electromagnetic resonators are arranged to have substantially no real component of coupling coefficients between each other.

3. The electro-optic device of claim 1 or 2, wherein each electrode of said first plurality of electrodes is electrically connected to a respective one of said plurality of electromagnetic resonators, and
wherein each electrode of said second plurality of electrodes is electrically connected to a respective one of said plurality of electromagnetic resonators such that each of said plurality of electromagnetic resonators can be electronically addressed for at least one of detection or transmission of electromagnetic energy at corresponding resonating wavelengths.

4. The electro-optic device of claim 1, wherein each of said plurality of electromagnetic resonators absorbs at a wavelength of light for detection.

5. The electro-optic device of claim 1, wherein each of said plurality of electromagnetic resonators emits at a wavelength of light for emission.

6. The electro-optic device of claim 1, wherein said plurality of electromagnetic resonators includes at least one resonator that resonates at a frequency of blue light, at least one resonator that resonates at a frequency of green light, and at least one resonator that resonates at a frequency of red light.

7. The electro-optic device of claim 1, wherein each said plurality of electromagnetic resonators resonates at a different frequency, and wherein said electro-optic device is a spectrometer.

8. The electro-optic device of claim 1, wherein said plurality of electromagnetic resonators is sensitive to a polarization of light incident upon said first or second electrode.

9. The electro-optic device of claim 1, wherein said plurality of electromagnetic resonators forms an array of at least one of electromagnetic detectors or electromagnetic emitters.

10. The electro-optic device of claim 1, wherein a shortest distance between any two of said plurality of electromagnetic resonators is less than a wavelength of light absorbed or emitted by said plurality of electromagnetic resonators.

11. The electro-optic device of claim 1, wherein said plurality of electromagnetic resonators includes at least one resonator that resonates at a frequency of ultraviolet light.

12. The electro-optic device of claim 1, wherein said plurality of electromagnetic resonators includes at least one resonator that resonates at a frequency of near-infrared light.

13. A method of forming an electro-optic device, comprising:
forming a first plurality of electrodes;
forming an active layer electrically connected to said first plurality of electrodes, said active layer comprising a plurality of electromagnetic resonators; and
forming a second plurality of electrodes electrically connected to said active layer,
wherein said forming said active layer comprises forming at least two electromagnetic resonators at a distance from each other that is less than the resonance wavelengths of each of said two electromagnetic resonators and such that a real component of a coupling coefficient between said at least two electromagnetic resonators is substantially canceled.

14. The method of claim 13, wherein each electrode of said first plurality of electrodes is formed to be electrically connected to a respective one of said plurality of electromagnetic resonators, and
wherein each electrode of said second plurality of electrodes is formed to be electrically connected to a respective one of said plurality of electromagnetic resonators such that each electromagnetic resonator can be electrically addressed for at least one of detection or transmission or emission at a corresponding resonance wavelength.

15. The method of claim 13, wherein said plurality of electromagnetic resonators are formed in an array.

16. The method of claim 13, wherein said array is a hexagonal array comprising three resonators per hexagon.

17. The method of claim 13, wherein each of said plurality of resonators has a cylindrical shape.
